(19) United States
(12) Patent Application Publication
(10) Pub. No.: US 2005/0117558 A1
(43) Pub. Date: Jun. 2, 2005

(54) Method for reducing data transport volume in data networks

(75) Inventors: Michael Angermann, Grafelfing (DE); Jens Kammann, Gilching (DE); Patrick Robertson, Ammerland (DE); Christian Wasel, Munchen (DE)

Correspondence Address: WILLIAM COLLARD;COLLARD & ROE, P.C., 1077 NORTHERN BOULEVARD, ROSLYN, NY, 11576, US

(73) Assignee: Deutsches Zentrum fur Luft-und Raumfahrt e. V.

(21) Appl. No.: 11/002,602

(22) Filed: Dec. 2, 2004

(30) Foreign Application Priority Data
Dec. 2, 2003 (DE) 103 56 724.0

(51) Int. Cl. H04Q 7/24

(52) U.S. Cl. 370/338

(57) ABSTRACT

Formed in a proxy server (CP) from the data output by a server application (SA) in response to a client (CA) inquiry is a message digest (MD) which is checked in said proxy server by comparison as to whether an identical message digest is already cached in the proxy server for said client. If so, a brief response message (HIT) is communicated by the proxy server to said client (CA) signalizing that the content can be found in the cache of a mobile proxy (MP) assigned to said client. If not, the complete content including the message digest serving as a key is communicated to the proxy of said client (CA) for caching there. Application in mobile data services requiring data transport via wireless networks.

### FIELD OF THE INVENTION

The invention relates to a method for reducing data transport volume in data networks wherein content already communicated from a data source to a client over a communication link is cached at the client for later re-use. One such method is known from EP 1 308 853 A1.

### PRIOR ART

Since transporting data in data networks invariably costs time and money a variety of techniques is employed to reduce the data transport volume. One method often put to use for this purpose involves storing data already communicated to the client for later re-use, in other words “caching”, albeit with the problem of checking or maintaining the cached data updated.

This problem is not only involved when prefetching content but also when copies of the data are to be maintained, invariably involving the risk of the original data being changed, since any such change means that the copy becomes stale or invalid; stale meaning in this case that the original data has changed whilst invalid means that the copy has become stale with negative effects on use. It usually needs to be avoided that a data consumer receives stale data. Algorithms and protocol extensions prevent use of such stale data in so-called cache invalidation schemes as have since become a field of intense research termed cache consistency.

For cache configuration and application considered here a distinction is made between four well-known and fundamentally different schemes, namely temporal invalidation, location-dependent invalidation, active validation/invalidation by the client and invalidation by call-back.

Temporal invalidation uses an expiration date which is assigned to the copy of the data. After this expiration date the copy is considered stale. This scheme is realized in HTTP by transferring the expiration date with the optional Expires header field (e.g. Expires: Wed, 31 Dec. 2003 18:00:00 GMT) . It should be noticed that this scheme is not a general solution to the cache consistency problem, it instead constituting an agreement between the consumer and the provider of the data where the provider assures that the original will not be changed until the expiration date, or if it is changed before the expiration date no negative effects are caused by using the stale copy (i.e. the data is stale but not invalid).

Location-dependent invalidation has been proposed in the paper by B. Zheng, J. Xu, D. L. Lee. “Cache invalidation and Replacement strategies for location-dependent data in Mobile Environments in IEEE Transactions on Computers”, Vol. 51, No. 10, October 2002, pages 1141 to 1153. This scheme considers the case of a mobile user with known geographical position for whom data is considered to be valid only if he is within a certain geographical region. As an example, the query for “the nearest restaurant” is given. The result for this query clearly depends on the user's location. Once the user has moved into a region where another restaurant is closer, the old result is no longer valid. To achieve sensible validation it is proposed to store a region, called valid scope area, with the copy of the data, in observing that queries that specify the search for an object with the predicate “nearest” becoming patches of a Voronoi diagram. The data is then considered stale and invalid when the user leaves the valid scope area.

When active validation by client is employed, the client has the responsibility to validate the copy each time the copy is accessed, it therefore actively contacting the server containing the original data in asking whether the original data has been changed since the time instant the copy was made. For this purpose the cache instance stores this time instant with the copy. Within the HTTP protocol this scheme is employed wherever a client uses a method (usually GET) and makes it conditional by an “If_Modified_Since header (e.g. If_{—Modified}_Since: Thurs, 27 Mar. 2003 11:20:00 GMT). If the document has changed since the specified time, the server returns the newer version. If it has not changed the server returns an error code (304) that tells the client that the copy is still valid.

The invalidation by call-back scheme requires the server to keep track of all copies that have been made. Whenever the original data is changed the server actively notifies all instances that keep copies that a newer version exists. This scheme is not realized within the HTTP protocol.

Another important issue that has a strong practical influence on caching and prefetching is dynamically generated content. A large and increasing number of websites makes use of the modern webserver's ability to keep track of user sessions by dynamical generation of the links e.g. within HTML files. When a request corresponding to a dynamically generated link arrives at the server, the server application is capable of separating the information as to the necessary data from the additional information that is used for keeping track of sessions. As a result, it frequently occurs that identical content is served under multiple distinct URLs. Frequently, the adverse effects of this phenomenon are mentioned as arguments against the employment of caching and prefetching as the percentage of cacheable documents can be significantly reduced. FIG. 1 shows this case by way of an example with two different URLs and identical, dynamically generated content.

A similar phenomenon occurs also for static content in cases where the same data e.g. a certain image used for an icon is used by multiple websites under potentially distinct filenames. This effect is not a hindrance to caching and prefetching as all instances of the data are cacheable and can be re-used. Nevertheless, additional transmission and storage resources could be conserved if the quality/identity of the data could be detected. FIG. 2 shows this case by way of an example with two different URLs and identical, statically generated content.

Existing schemes for cache validation are thus hampered particularly where involving dynamically generated content especially by web applications or scripts such as e.g. PHP, ASP, Servlets, JSP or Perl. For one thing, data whose URL has changed or has been generated dynamically are repeated in transmission unnecessarily, although the same in content, and for another, data whose URL has remained the same are not repeated in transmission despite it being necessary.

These issues as to cache consistency and dynamically content generation have been elaborated to make for a better understanding of the method as presented by the present invention.

### SUMMARY OF THE INVENTION

In schemes in which data already communicated from a data source to a client is cached at the client for later re-use, the invention is based on the object of maintaining the cached data updated or in synchronism with the data of the data source without requiring any cooperation of the data source operators.

In accordance with the invention relating to a method of the aforementioned kind this object is achieved to advantage by the steps of:
forming in a proxy server a message digest from the response data output by a data source in response to a request of the client similar to a sum check
checking said message digest in the proxy server by comparison whether an identical message digest has already been cached for said client, and if so,
communicating said client from said proxy server together with said message digest a short response message signalizing the fact that said content can be found in the cache of said client or of a proxy assigned to said client which uses said message digest as a key for retrieving said content from his cache and furnishing said content to said client to whom said content is then presented, and
communicating the complete content including the message digest to the client in response only after having established in the proxy server assigned to said data source (SA) in the comparative check of the message digest (MD) that no identical message digest has already been cached, the content being cached together with the message digest serving later identification as the key in the cache of the proxy assigned to the client.

Employing a proxy system which can be termed a split proxy with cache and hashing functionality, and checking and comparing the data by way of the message digest as may be configured similar to the check sum e.g. RFC 1321 (MD5) results in total achievement of the cited object without requiring any cooperation of the data source operators.

The method in accordance with the invention now makes it possible for the end user and/or the operator of the gateway networks to fully exploit the latter in thus saving time and money as is particularly of major significance where mobile wireless networks are concerned.

The method in accordance with the invention comprises a special working architecture, algorithm and protocols in a combination which achieves the object especially where typical wireless scenarios are involved. The method is particularly effective when assuming for a wireless access link the communication capacity is significantly smaller than and the latency significantly higher than within an adjoining core network.

When this is the case, it is now feasible and beneficial to attempt validation of all content even when this is not explicitly approved for caching, the method in accordance with the invention no longer making use of URLs or URIs to identify and index data. Instead, advantageous use is made of message digestion algorithms such as e.g. MD5 and SHA-1 with a proven record of success in facilitating a fast comparison of data for equality. This now makes it possible to check for validity of content without any regard whatsoever of the—potentially dynamically—assigned label of the data.

Advantageous aspects of the method in accordance with the invention read from the sub-claims relating back to claim 1 directly or indirectly.

By its proxy, as regards its configuration, the client can now operate to great advantage his mobile wireless information device with access to data services such as e.g. WAP or web as well as to all further services for mobile end devices such as mobile telephones, PDAs or laptops, for example. In this arrangement, communication between the proxy of the client residing within the mobile wireless information device and the proxy server is undertaken either via a PLMN or via a resident proxy communicating via a short-range wireless system such as e.g. Bluetooth or W-LAN to the proxy of the client and POTS to which both the resident proxy and the proxy server assigned to the data source are linked.

### DESCRIPTION OF THE DRAWINGS

The method in accordance with the invention will now be detailed with reference to the drawings in which:

FIG. 1 is a block diagram illustrating the case as known and already described of an example with two different URLs involving identical dynamically generated content,

FIG. 2 is a block diagram illustrating the case as likewise known and already described of an example with two different URLs involving identical statically generated content,

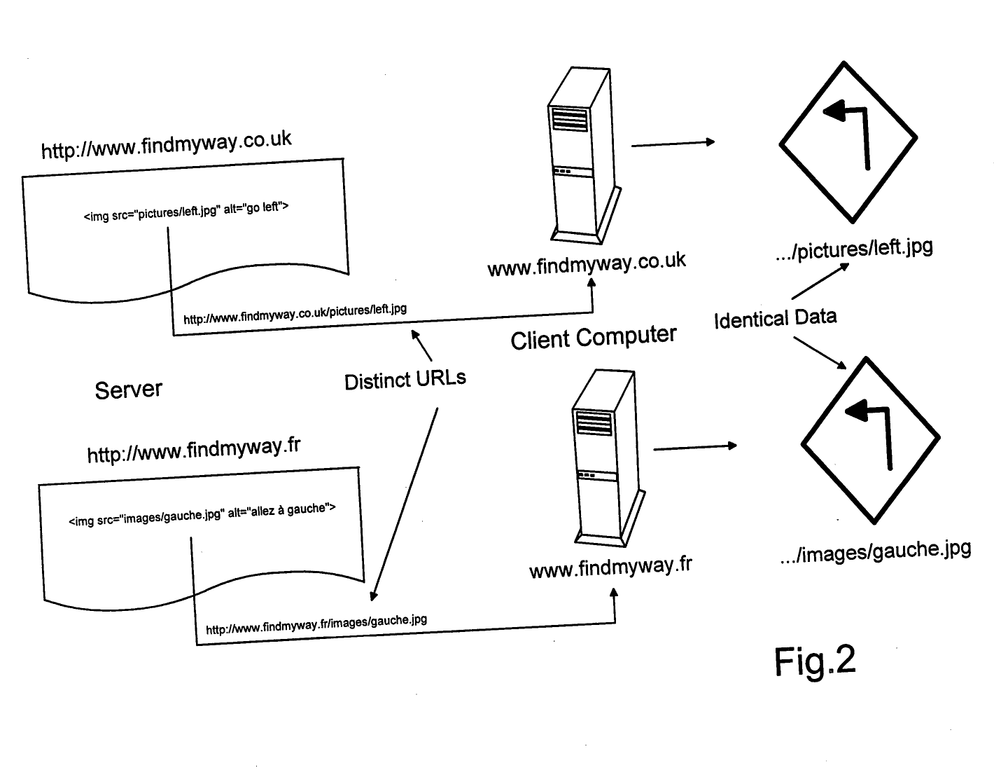

FIG. 3 is a diagrammatic illustration, by way of example, of the full architecture of a system for implementing the method in accordance with the invention,

FIG. 4 is a chart illustrating the sequence of a hash protocol in making use of the method in accordance with the invention if no identical content was previously communicated by a server application to a client application,

FIG. 5 is a chart illustrating the sequence of a hash protocol in making use of the method in accordance with the invention when identical content was previously communicated by a server application to a client application with cache,

FIG. 6 is a graph illustrating the duration of the hash computing, in other words the message digest computing time, as a function of the data length for cases as realized in Table 1 with application of two different message digestion algorithms, namely MD5 and SHA-1.

### DESCRIPTION OF THE INVENTION

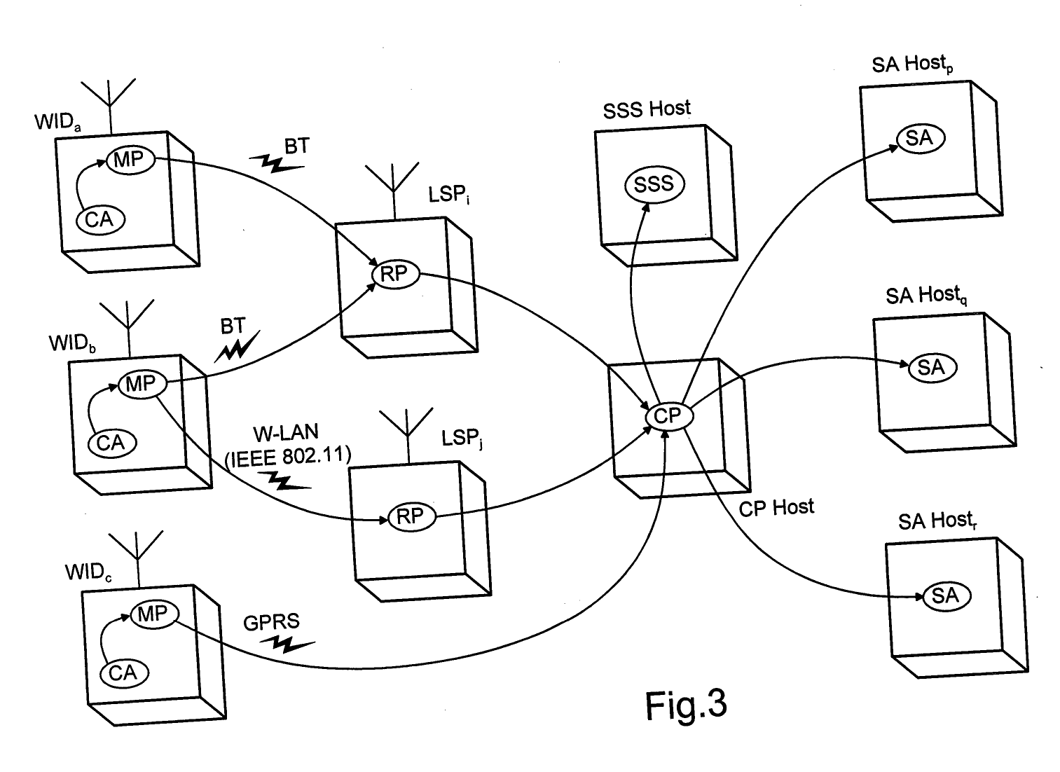

Referring now to FIG. 3 there is illustrated an example of the architecture of three wireless information devices WIDₐ, WID_{b} and WID_{c} each containing in the corresponding device configuration a client application CA and a mobile proxy MP. The client wireless information devices WIDₐ, WID_{b} and WID_{c} may be mobile telephones, PDAs or laptops, for example, all wireless linked. In this arrangement the mobile proxy MP of the first client information device WIDₐ communicates via a Bluetooth short range wireless link BT with a resident proxy RP of a local service point LSPᵢ.

The mobile proxy MP of the second client information device WID_{b} communicates via a Bluetooth short range wireless link BT with the resident proxy RP of the local service point LSPᵢ and via a W-LAN wireless link in accordance with IEEE 802.11 with the resident proxy RP of a second local service point LSPⱼ.

The third client information device WID_{c} with its mobile proxy MP does not reach a local service point, it instead communicating via a PLMN comprising GPRS functionality in this example of the architecture directly with a central proxy server CP assigned to three different server application SA with fetchable data sources to three host servers to which it is wired. Also wired to this central proxy server CP are the two local service points LSPI and LSPⱼ with their resident proxies RP. For statistics purposes a situation statistics server SSS is further linked to the central proxy server CP.

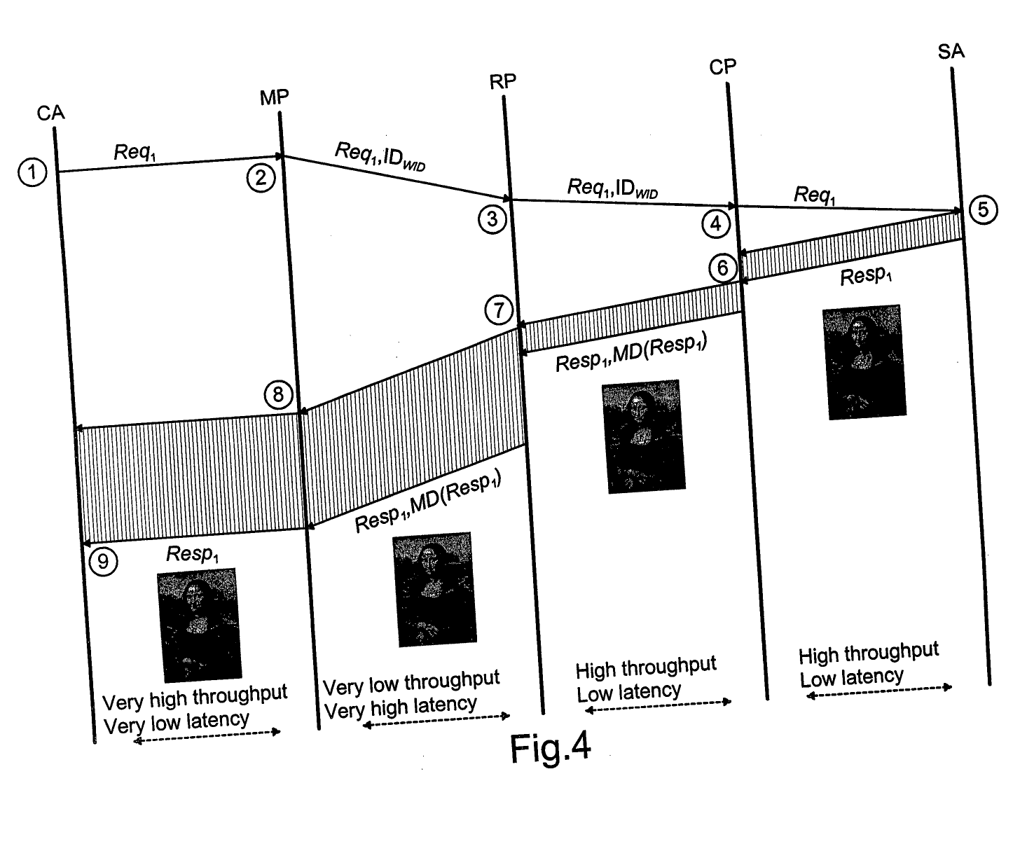

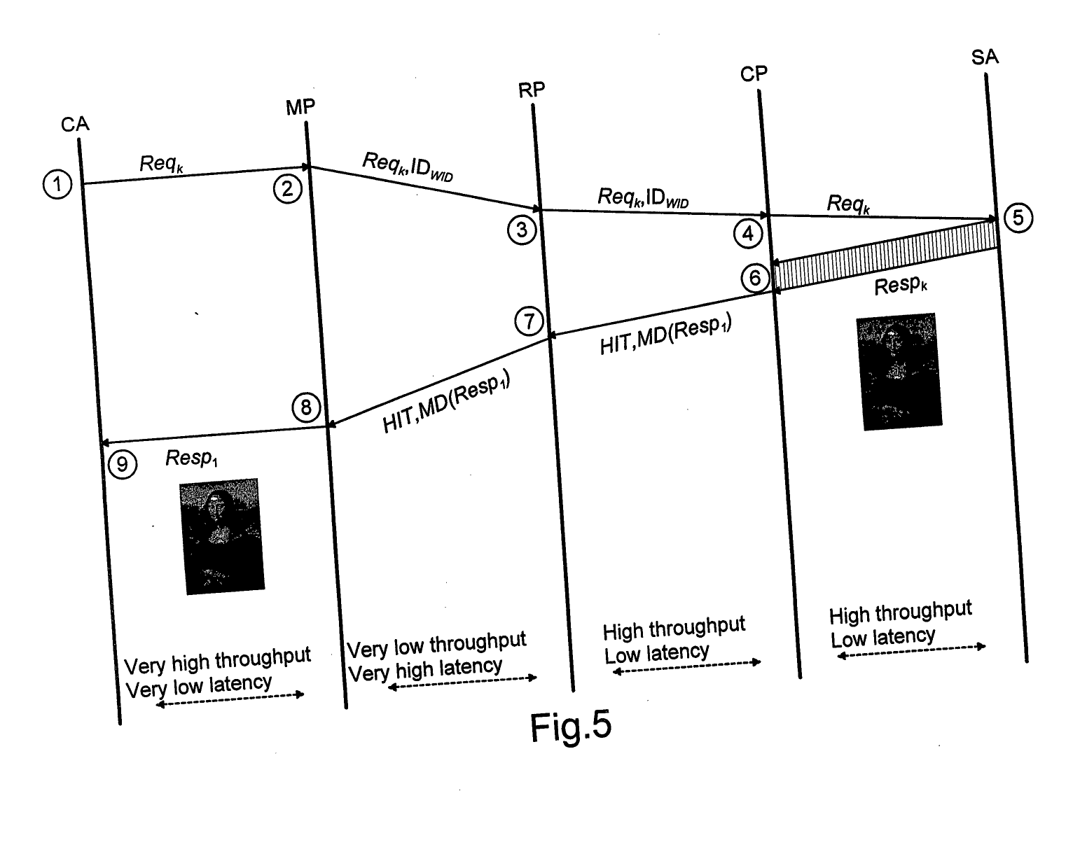

Referring now to FIG. 4 and FIG. 5 there is illustrated how the five entities CA (client application), MP (mobile proxy), RP (resident proxy), CP (central proxy server) and SA (server application) intercommunicate in accordance with a proposed hash protocol expediently put to use in clearing the aforementioned disadvantageous effects in generating dynamic content. It is important to bear in mind the considerable differences in the date rate, latency and costs involved in the various communication links.

The client application CA and mobile proxy MP reside on the same device so that it can be assumed that high data rates are achieved, whereas due to the character of the wireless medium the link between the mobile proxy MP and resident proxy RP will always be slower than all other links. These differences in the data rate and latency are indicated in FIG. 4 and FIG. 5 in which, for a better reference, events or steps of interest are identified by an encircled number, e.g. \mathring{1} in the text and FIGs.

Beginning at \mathring{1} it is here that the client application CA sends a request Req₁ to the mobile proxy MP residing on the same device. The mobile proxy MP includes a unique identity ID_{WID} identifying the wireless information device WID in the header and forwards at \mathring{2} the request Req₁ via a short wireless short-range communication to the resident proxy RP at a reachable local service point. From the resident proxy RP the request Req₁ is forwarded at \mathring{3} unchanged to the central proxy server CP which inturn forwards at \mathring{4} the request Req₁ to the actual server application SA at \mathring{5}. If no local service point is in reach, the resident proxy RP is skipped and the request Req₁ is forwarded directly via a PLMN and the appropriate gateways to the internet to the central proxy server CP at \mathring{4}.

The server application SA receives at \mathring{4} and parses at \mathring{5} the request Req₁, generating the response Resp₁ with the requested data in thus starting to send this data—which in this example is the data of a picture—to the central proxy server CP. Typically there is no need to include the identity ID_{WID} in the response Resp₁ since all communications inbetween are connection-oriented, thus automatically associating the response Resp₁ with the corresponding request.

Although this applies as common practice for transporting HTTP traffic over TCP this is not mandatory since HTTP messages can be transported also via connection-less (e.g. UDP) oder message-oriented (e.g. e-mail) channels between proxys. In this case the method in accordance with the invention requires including in the responses also information identifying each wireless information device WID.

At \mathring{6} the central proxy server CP waits until the complete response Resp₁ has arrived, it then computing the message digest of the data included in the response Resp₁. For each wireless information device WID served by the central proxy server CP the latter lists the message digests of all response data sent to the particular wireless information device WID. If the data was not sent before to the wireless information device WID, its message digest MD is not listed.

Referring now to FIG. 4 there is illustrated how in this case how at \mathring{6} the central proxy server CP includes the message digest in the list and in the response header in sending the complete response Resp₁ to the resident proxy RP which implements no operation whatsoever on the data or headers, it starting directly the procedure \mathring{7} in forwarding the data streaming from the resident proxy RP to the mobile proxy MP between which communication is relatively slow, as already mentioned. This is why the data arriving from the central proxy server CP needs to be queued.

Once the initial bytes of the response Resp₁ have arrived at the mobile proxy MP at \mathring{8}, forwarding them to the client application CA is commenced. This link is usually the fastest in the communication chain, due to the fact that transport is by interprocess communication within a device, so that, as a rule, no, or only brief, queuing is needed. The included message digest is stored in a table together with the response data for potential later reuse. After this, the complete response Resp₁ is forwarded at \mathring{9} to the client application CA. The client application CA can then present the results to the user or parse the description of the document for references pointing to embedded objects.

Referring now to FIG. 5 there is illustrated how despite the complication in applying the method in accordance with the invention the communication load is reduced.

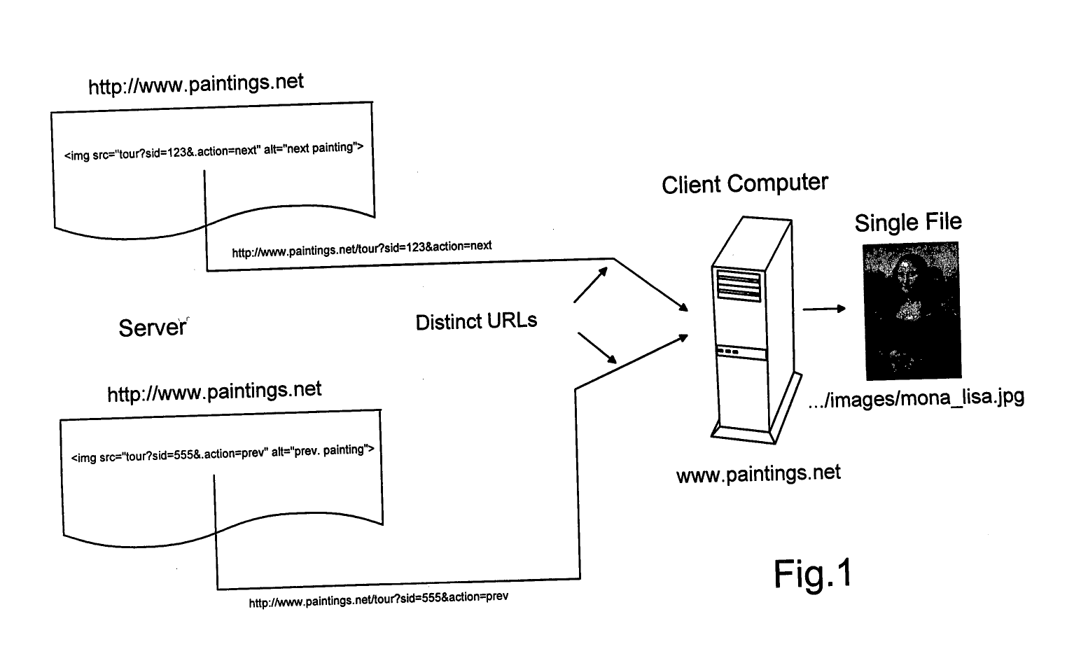

When at some later point in time the client application CA wishes to output a further data communication request Reqₖ, the steps \mathring{1} to \mathring{4} relating to handling a request Reqₖ are identical to those in the case as already explained with reference to FIG. 1, except that, this time, data included in the response Respₖ at \mathring{5} are an exact copy, in other words, the same picture in the example as described, of the data already transported once before to the wireless information device WID.

This circumstance is detected, since in the central proxy server CP the message digest MD of this response Respₖ is computed and, this time, is found in the list held for the particular wireless information device WID in the central proxy server CP. The central proxy server CP then generates at \mathring{6} a response with a header signalizing the fact that the data can be found (HIT) on the particular wireless information device WID and with the message digest (Resp₁).

This brief response HIT, MD (Resp₁) is sent at \mathring{6} from the central proxy server CP to the resident proxy RP, forwarded at \mathring{7} from the resident proxy RP to the mobile proxy MP where it is received at \mathring{8}. The mobile proxy MP uses the message digest MD (Resp₁) as a key for retrieving the data from its cache and delivers it as a full response Resp₁ to the client application CA where the content is then presented at \mathring{9} in the form of the picture in this example.

It is to be emphasized that no cooperation of server applications SA is needed to deploy the method in accordance with the invention.

Although it needs to be taken into account that computing the message digest will consume resources and time in thus introducing an additional latency, trials have already been performed, as listed in Table 1, for two different message digest algorithms, namely MD5 and SHA-1 on three different platforms for assessing this unwanted additional latency.

TABLE 1

| Host-Server | | | |
|---|---|---|---|
| (SA) | Processor | Memory | Operating system |
| onyx | Pentium IV | 512 MByte | MS Windows 2000 |
| | 2 GHz | | |
| carla | Pentium IV | 512 MByte | Linux 2.4 |
| | 2 GHz | | |
| goldeneye | UltraSPARC-IIe | 2048 MByte | SunOS 5.8 |
| | 500 MHz | | |

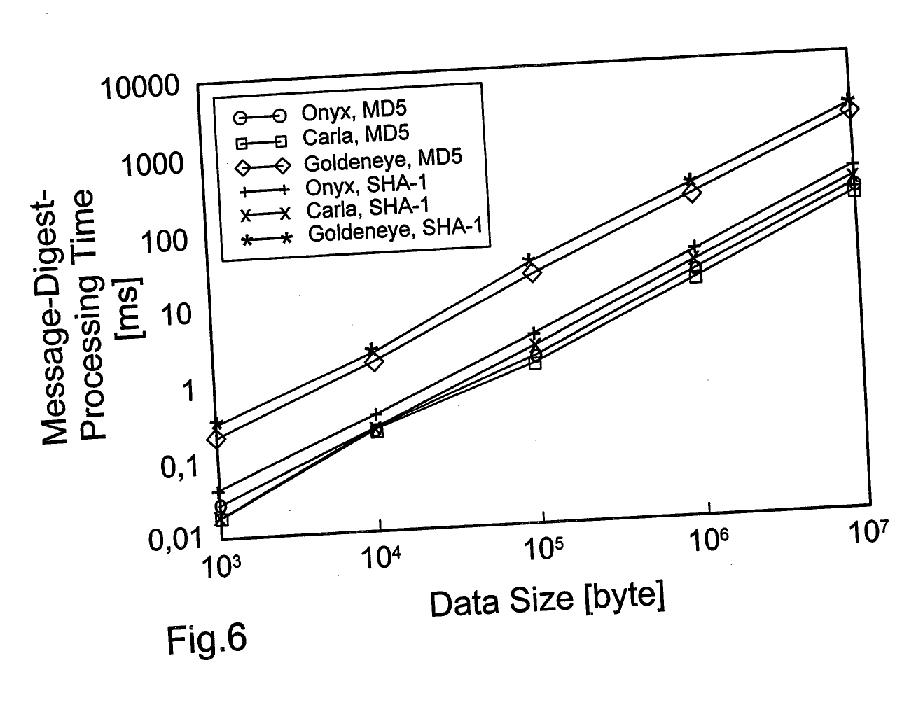

Of particular interest is the type of increase (linear, polynomial, exponential, . . . ) in computation time as a function of message digest size. The results are plotted in the graph as shown in FIG. 6 proving that the time needed for computing message digests (ms) is moderate with only a linear increase with increasing message digest size (byte). Indeed, it is obvious that MD5 works marginally faster than SHA-1 on all platforms due to, in part, the smaller message digest size for MD5. In all, the results show that the delays because of the computing time for any given message digest size are significantly smaller than the delays caused by limiting the data transmission rate.

It is thus to be viewed advisable to employ the method working in accordance with the invention for cache validation especially in dynamic content generation and service provisioning for mobile devices. Without this constituting any preference, MD5 was selected as the default message digest algorithm within a proposed protocol because of its adequate length, its slightly faster computation time and its availability for a wealth of different platforms.

1. A method for reducing data transport volume in data networks wherein content already communicated from a data source (SA) to a client (CA) over a communications link is cached at said client (CA) for later re-use, comprising the steps of:
forming in a proxy server (CP) a message digest (MD) from the response data output by a data source (SA) in response (Resp) to a request (Req) of said client (CA) similar to checksumming
checking said message digest (MD) in said proxy server (CP) by comparison whether an identical message digest (MD) has already been cached for said client (CA), and if so,
communicating said client (CA) from said proxy server (CP) together with said message digest (MD) a short response message (HIT) signalizing the fact that said content can be found in said cache of said client (CA) or of a proxy assigned to said client (CA) which uses said message digest (MD) as a key for retrieving said content from his cache and furnishing said content to said client (CA) to whom said content is then presented, and
communicating said complete content including said message digest (MD) to said client (CA) in response only after having established in said proxy server (CP) assigned to said data source (SA) in said comparative check of said message digest (MD) that no identical message digest (MD) has already been cached, said content being cached together with said message digest (MD) serving later identification as said key in said cache of said proxy assigned to said client (CA).

2. The method as set forth in claim 1 wherein the MD5 or SHA-1 algorithm is employed as the message digestion algorithm in said proxy server (CP) assigned to said data source (SA) in checking said message digest (MD) in comparison to the hashing functionality to speed up comparing data for identity.

3. The method as set forth in claim 1 wherein said client (CA) is operated with its proxy (MP) in a wireless information device (WID) for use in data services such as e.g. WAP or web.

4. The method as set forth in claim 3 wherein communication between said proxy (MP) of said client (CA) accommodated in said mobile wireless information device (WID) and said proxy server (CP) is undertaken either via a PLMN or via a resident proxy (RP) communicating via a short-range wireless system such as e.g. Bluetooth or W-LAN to said proxy of said client (CA) to which both said resident proxy (RP) and said proxy server (CP) are linked.

5. The method as set forth in claim 1 wherein said mobile proxy (MP) is integrated in said client application (CA).

6. The method as set forth in claim 1 wherein said central proxy server (CP) is integrated in said server application (SA).

7. The method as set forth in claim 1 wherein in said central proxy server (CP) statistical data is gathered and stored.
